(19) United States
(12) Patent Application Publication
(10) Pub. No.: US 2015/0000763 A1
(43) Pub. Date: Jan. 1, 2015

(54) VALVE BODY FOR A SNAP-IN VALVE AND SNAP-IN VALVE

(71) Applicant: CONTINENTAL AUTOMOTIVE GMBH, HANNOVER (DE)

(72) Inventors: CARLA RECKER, HANNOVER (DE); GWENN LELIEVRE, TOULOUSE (FR); VOLKER HAERTEL, GERMERING (DE); KONSTANTIN EFIMOV, HANNOVER (DE)

(21) Appl. No.: 14/317,157

(22) Filed: Jun. 27, 2014

(30) Foreign Application Priority Data
Jun. 27, 2013 (EP) 13174015

(51) Int. Cl. F16K 15/20; B60C 29/02

(52) U.S. Cl. CPC F16K 15/202; B60C 29/02
USPC 137/223

(57) ABSTRACT

A valve body for a snap-in valve of a vehicle wheel includes a valve stem having a valve core and a jacket-shaped body connected fixedly to the valve stem having the valve core. The body is formed of a rubber mixture containing chloroprene rubber. A snap-in valve having the valve body is also provided.

### CROSS-REFERENCE TO RELATED APPLICATION

This application claims the priority, under 35 U.S.C. §119, of European Patent Application EP 13 174 015, filed Jun. 27, 2013; the prior application is herewith incorporated by reference in its entirety.

### BACKGROUND OF THE INVENTION

### Field of the Invention

The invention relates to a valve body for a snap-in valve including a valve stem having a valve core and a jacket-shaped or jacket-like body connected to the valve body. The jacket-shaped body contains a rubber mixture. The invention further relates to a snap-in valve.

Valves which are customary and constructed in accordance with the prior art, for vehicle wheels formed of a rim and a pneumatic vehicle tire, are known from European Patent Application EP 0 206 002 A2, corresponding to U.S. Pat. No. 4,768,574; International Publication No. WO 2007/112920 A1, corresponding to U.S. Pat. No. 8,047,247; International Publication No. WO 2009/024220 A1, corresponding to U.S. Pat. No. 8,312,904; International Publication No. WO 2010/075967 A1, corresponding to U.S. Patent Application Publication No. 2011/0248204; and European Patent EP 2 176 076 B1, corresponding to U.S. Pat. Nos. 8,286,474 and 7,587,935, for example. The valve bodies of those valves are jacket-shaped bodies which are manufactured primarily from rubber mixtures, the rubber component of which is formed of NR/EPDM blends or SBR/EPDM blends. The rubber bodies of valves which are provided with a housing to accommodate an electronic unit, of the kind which is known from International Publication No. WO 2010/075967 A1, corresponding to U.S. Patent Application Publication No. 2011/0248204 or European Patent EP 2 176 076 B1, corresponding to U.S. Pat. Nos. 8,286,474 and 7,587,935, for example, are subject to relatively high loads. The rubber bodies manufactured from the customary rubber mixtures do not have the desired durability and thus are candidates for improvement, in particular in terms of their heat resistance, crack resistance, stiffness, and ozone resistance.

### SUMMARY OF THE INVENTION

It is accordingly an object of the invention to provide a valve body for a snap-in valve and a snap-in valve, which overcome the hereinafore-mentioned disadvantages of the heretofore-known valve bodies and valves of this general type and which provide a jacket-shaped body for a valve that does not have the aforementioned drawbacks.

With the foregoing and other objects in view there is provided, in accordance with the invention, a valve body for a snap-in valve of a vehicle wheel, the valve body comprising a valve stem with a valve core and a jacket-shaped body fixedly connected to the valve stem having the valve core. The jacket-shaped body is formed of a rubber mixture containing chloroprene rubber.

Jacket-shaped bodies manufactured from a rubber mixture including chloroprene rubber are notable for particularly effective resistance toward embrittlement, effects of weathering, in particular ozone, and for good heat resistance. Chloroprene rubber, moreover, can be processed well with other polymers to form polymer blends, particularly with natural rubber (NR) or with ethylene-propylene-diene rubber (EPDM), for the purpose, for instance, of improving the low-temperature flexibility, and also, furthermore, with styrene-butadiene rubber (SBR) and other rubbers.

In accordance with another feature of the invention, in order to provide effective resistance toward embrittlement and effects of weathering, in particular ozone, and also for effective heat resistance on the part of the jacket-shaped body, the fraction of chloroprene rubber in the rubber mixture of the jacket-shaped body ought to be between 30 phr and 100 phr, preferably at least 50 phr, in particular at least 75 phr.

In accordance with another feature of the invention, the rubber mixture of the jacket-shaped body may include not only chloroprene rubber but also at least one of the rubbers from the group of the diene rubbers such as, for example, natural rubber, ethylene-propylene-diene rubber, butadiene rubber, isoprene rubber and/or styrene-butadiene rubber, and the rubbers may have been functionalized. Through the admixtures of further types of rubber it is possible to tailor particular properties of the jacket-shaped body: for example, the properties of adhesion to the valve stem with the valve core, or the flexibility and/or stiffness.

With the objects of the invention in view, there is also provided a snap-in valve for a vehicle wheel having a rim and a pneumatic vehicle tire, the valve comprising a valve body constructed in accordance with the invention.

In accordance with a concomitant feature of the snap-in valve of the invention, the valve body is connected to an electronics housing. The electronics housing may be connected to the valve body before or after assembly, and the connection may optionally also be undone.

The jacket-shaped bodies of the invention are particularly advantageous especially for these valves, due to the relatively high mechanical loads.

Other features which are considered as characteristic for the invention are set forth in the appended claims.

Although the invention is illustrated and described herein as embodied in a valve body for a snap-in valve and a snap-in valve, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a valve body of an exemplary snap-in valve; and

FIGS. 2 and 3 are diagrams determined from samples of vulcanizate.

### DETAILED DESCRIPTION OF THE INVENTION

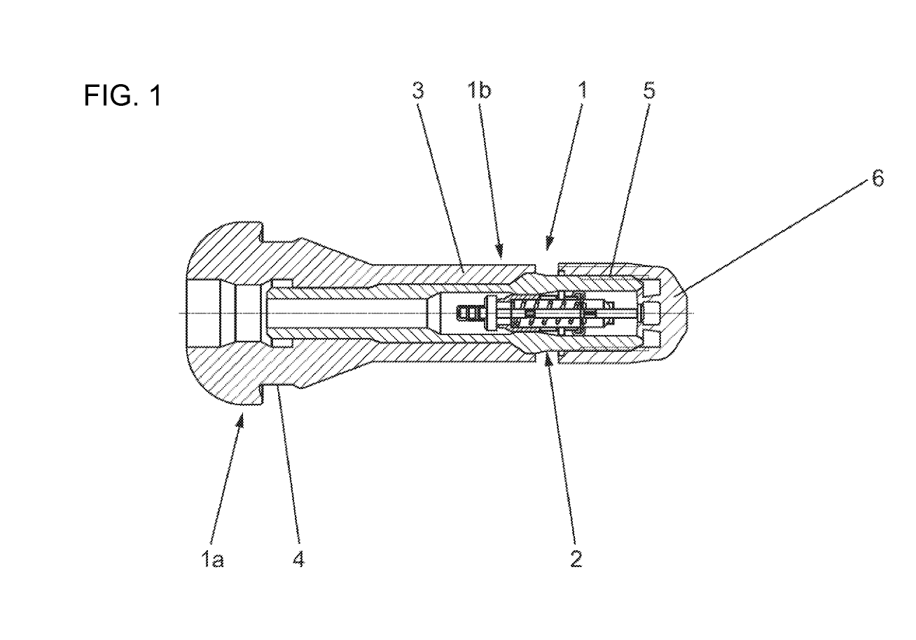

Referring now to the figures of the drawings in detail and first, particularly, to FIG. 1 thereof, there is seen an embodiment of a customary valve body 1 of a valve for a vehicle wheel having a rim and a pneumatic tire. The valve body 1 is formed of a valve stem with valve core 2, which may be constructed in accordance with the prior art and which is connected fixedly on the external side to a jacket-shaped rubber body 3, which has been partly vulcanized for adhesion, for example. In the assembled state, the valve body 1 passes through a drilled rim hole in the non-illustrated rim and has a valve body portion 1a which protrudes into the rim interior with the valve assembled. The valve body 1 also has a valve body portion 1b which protrudes outwardly beyond the rim. The edge of the aforementioned rim hole is seated in an annular groove 4 which is formed on the valve body 1 between the valve body portions 1a and 1b. A free end portion of the valve stem with the valve core 2 carries an external thread 5, onto which a valve cap 6 can be screwed.

In accordance with the invention, the jacket-shaped body 3 is manufactured from a rubber mixture which includes chloroprene rubber. The fraction of chloroprene rubber in the mixture is at least 30 phr, in particular at least 50 phr, and preferably between 75 and 100 phr, and chloroprene rubber may be used, in particular, in combination with one or more of the following rubbers: natural rubber, ethylene-propylene-diene rubber (EPDM), butadiene rubber (BR), isoprene rubber (IR) or styrene-butadiene rubber (SBR). The other mixture constituents of the rubber mixture correspond to the customary mixture constituents for rubber mixtures based on chloroprene and other diene rubbers for industrial rubber products or pneumatic vehicle tires, as are described, for example, in the Handbuch für die Gummi-Industrie [Handbook for the Rubber Industry], 2^{nd} edition (published by Bayer AG, 1991).

Table 1 below gives mixture examples In₁ and In₂ of rubber mixtures according to the invention, and two mixture examples Pa₁ and Pa₂ for prior-art rubber mixtures, which are in each case mixtures for jacket-shaped bodies 3 of valve bodies 1. The fractions of the mixture constituents are given in phr and are therefore based on 100 parts by weight of rubber in the respective mixture.

TABLE 1

| | In₁ | In₂ | Pa₁ | Pa₂ |
|---|---|---|---|---|
| Chloroprene rubber | 100 | 100 | — | — |
| EPDM | — | — | 30 | 30 |
| Natural rubber | — | — | 70 | — |
| SBR 1500 | — | — | — | 70 |
| Carbon black N220 | 35 | 47.5 | 68 | 66 |
| Silica | 5 | 5 | 8 | 8 |
| Mineral oil | — | 5 | 30 | 28 |
| Ester plasticizer | 10 | 10 | — | — |
| Accelerator | 2.4 | 2.4 | 2.9 | 3.6 |
| Sulfur | — | — | 0.9 | 0.6 |
| Zinc oxide | — | 5 | 5 | 4 |
| Processing assistant | 5 | 5 | 1.8 | 1.8 |
| Aging inhibitor | 4.0 | 4.8 | 2.25 | 2.25 |

The jacket-shaped bodies 3 of the valve bodies 1 according to the invention have a substantially greater durability than the jacket-shaped bodies manufactured in accordance with the prior art for valve bodies for snap-in valves that include, for example, a blend of NR/EPDM (example Pa1) or SBR/EPDM (example Pa2) in the rubber component. The significantly better durability is attributable, in particular, to the greater heat resistance of chloroprene rubber.

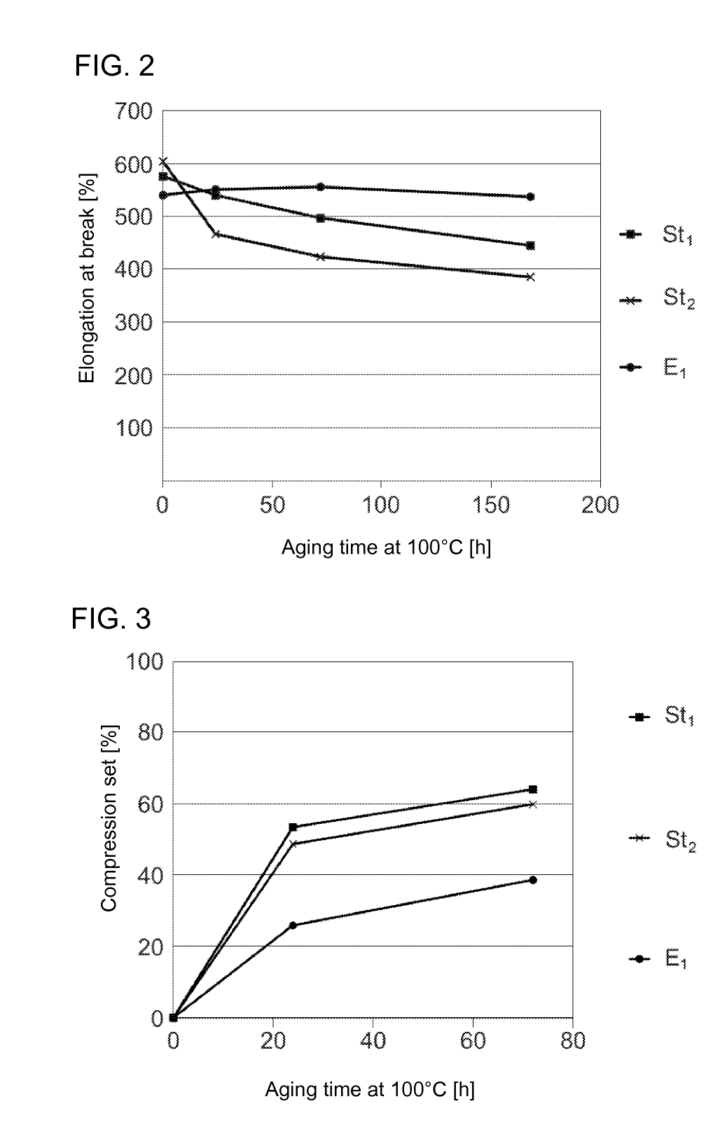

Vulcanizate samples were prepared from the rubber mixture In1 according to the invention and also from the prior-art rubber mixtures Pa1 and Pa2, and were tested for their aging behavior in accordance with the norms of the German Institute for Standardization DIN ISO 5725 (FIG. 2) and DIN ISO 815 (FIG. 3). In the diagram shown in FIG. 2, the elongation at break [%] is plotted against the aging time [h] at 100° Celsius for the three samples of vulcanizate. The vulcanizate composed of the chloroprene rubber mixture exhibits a virtually unchanged elongation at break over time, while the vulcanizates composed of the prior-art mixtures do significantly less well. In the diagram shown in FIG. 3, the compression set [%] is plotted against the aging time [h] at 100° Celsius. In this case as well, relative to the vulcanizates composed of the prior-art rubber mixtures, the vulcanizate composed of the chloroprene rubber mixture according to the invention exhibits a significantly better result.

Valve bodies with jacket-shaped bodies 3 manufactured in accordance with the invention from a chloroprene rubber mixture may be valve bodies for conventional snap-in valves, but may also be valve bodies of valves which are connected to an electronics housing that is positioned in the rim interior in order, in particular, to accommodate electronic components which measure operating parameters of the vehicle wheel, such as the internal tire pressure, for example. These valves, in particular, are subject to relatively high mechanical loads, and it has emerged that valves of this kind with valve bodies constructed in accordance with the invention stand up particularly well and durably to these loads.

1. A valve body for a snap-in valve of a vehicle wheel, the valve body comprising:
a valve stem with a valve core; and
a jacket-shaped body fixedly connected to said valve stem having said valve core;
said jacket-shaped body being formed of a rubber mixture containing chloroprene rubber.

2. The valve body according to claim 1, wherein said jacket-shaped body contains a fraction of between 30 phr and 100 phr of said chloroprene rubber in said rubber mixture.

3. The valve body according to claim 2, wherein said fraction of said chloroprene rubber in said rubber mixture of said jacket-shaped body is at least 50 phr.

4. The valve body according to claim 2, wherein said fraction of said chloroprene rubber in said rubber mixture of said jacket-shaped body is at least 75 phr.

5. The valve body according to claim 1, wherein said rubber mixture of said jacket-shaped body contains, in addition to said chloroprene rubber, at least one rubber selected from the group of diene rubbers including natural rubber, ethylene-propylene-diene rubber, butadiene rubber, isoprene rubber and styrene-butadiene rubber.

6. A snap-in valve for a vehicle wheel having a rim and a pneumatic vehicle tire, the snap-in valve comprising:
a valve body according to claim 1.

7. The snap-in valve according to claim 6, which further comprises an electronics housing connected to said valve body.
